(19) United States
(12) Patent Application Publication
(10) Pub. No.: US 2007/0099169 A1
(43) Pub. Date: May 3, 2007

(54) Software product and methods for recording and improving student performance

(76) Inventors: Darin Beamish, Puyallup, WA (US); Patrick Leonard, Kirkland, WA (US); Stefan Bolder, Tacoma, WA (US)

Correspondence Address: DWC LAW FIRM, P.S., P.O. BOX 3041, SEATTLE, WA, 98114-3041, US

(21) Appl. No.: 11/262,520

(22) Filed: Oct. 27, 2005

(51) Int. Cl. G09B 7/00

(52) U.S. Cl. 434/362; 434/322

(57) ABSTRACT

Software products and methods for recording student scores in relation to questions within a grading chart, the grading chart being displayable using a computer. The grading chart can be a matrix with fields that can be selected and used for visually entering scores corresponding to students and questions. The fields can be associated with pre-designated score alternatives, and the scores selected in the fields can be stored with individual associations to various educational standards-relevant factors.

### BACKGROUND

1. Field of the Invention

The following invention relates generally to data collection and use thereof for educational purposes, and in particular, to software and methods for use in collecting data and using data in monitoring, tracking and steering student performance.

2. Description of Related Art

Schools in the US are moving toward more rigorous standards-based methods of education. Recently, this trend is being driven by federal legislation in the No Child Left Behind Act (“NCLB”), which places pressure on states to pursue standards-based education reform. Under the NCLB, states develop content and achievement standards that are measured through assessments of student progress. Assessment results are compared with Adequate Yearly Progress (“AYP”) expectations that are tracked and used to hold states accountable for progress.

The NCLB requires that by the 2005-2006 school year, states must conduct annual assessments of public school students in 3^{rd}-8^{th} grade in reading and mathematics and at least one assessment for students during their 10^{th}, 11^{th} or 12^{th} grades. Thereafter, in 2007-2008, states will also be required to assess students at least once in science during each of the periods consisting of their 3rd through 5^{th} grade, 6^{th} through 9^{th} grade, and 10^{th} through 12^{th} grade education.

As stated, the NCLB holds states and schools accountable for achieving expectations. One feature of this accountability is that schools whose students under-perform will be identified, and can ultimately undergo restructuring, unless satisfactory progress is made toward measurable expectations. In the face of such high accountability for compliance, educators need to conduct ongoing assessments by administering frequent tests and quizzes to track and measure student progress and proficiency, with focused follow-up to steer students toward achieving and maintaining expectations. This involves data-intensive and consistent tracking, monitoring and evaluation of performance data on a more frequent basis than ever before. The urgency of this responsibility is apparent.

Some software tools are already available to assist educators in analyzing student performance data. However, data collection methods themselves present unique problems in this new test-intensive environment, where ongoing formative assessments in the form of tests and quizzes are administered on a constant basis on a small scale. Machine-scannable forms that are widely used for grading large-scale tests, are not always ideal for such smaller scale frequent tests and quizzes. Using scannable forms often requires preparation time (not to mention the fact that scanning equipment may be shared by multiple classrooms and inconveniently located), which may be well worth the time saved in grading larger scale tests, but can be time wasted when grading small scale tests or quizzes, which can be graded fairly quickly by hand. For example, educators often need to manually inspect and correct scannable forms when younger students have improperly marked or defaced the forms (e.g., educators need to inspect and erase stray marks to avoid errors during scanning). By the time such inspection and correction is complete, a teacher may well have already had enough time to grade a student's quiz. Also, the perceived benefits of anonymous grading by a machine are not critical when grading informal ongoing assessment quizzes and tests. In addition, the expenses associated with using reliable scannable forms can be reduced by hand-grading of formative assessments. Furthermore, in some circumstances, machine scanning is not appropriate where more open-ended answers are required, such that teacher judgment is necessary for scoring. Nonetheless, a bottleneck in hand grading often resides in manual entry of data into computers, and this can reduce the quantity or specificity of data that educators have time to enter, which could otherwise yield valuable information for educators. The present invention addresses this problem among others.

It is desirable to provide a cost effective alternative for scoring and data collection in connection with software tailored to assist educators in complying with standards-based education laws.

### BRIEF SUMMARY OF THE INVENTION

In various embodiments of the present invention, methods are provided for recording and analyzing student scores using a grading chart display, the grading chart having fields for selecting and recording individual student scores in relation to questions administered. The grading chart can be used with software for presenting questions that have been pre-linked to particular educational standards-relevant factors, such as state standard learning objectives. When the grading chart is used for recording scores, it can be automatically configured such that the fields of the grading chart are matched with individual questions in a question set being graded, and such that the scores entered into the grading chart are storable in association with standards-relevant factors corresponding to the questions. Furthermore, when the fields are matched with individual questions, pre-designated score alternatives can be linked to the fields and an educator entering scores can select from among the pre-designated score alternatives for each field. Selection of a score between the pre-designated alternatives can comprise, toggling or selecting from among a plurality of simultaneously displayable alternatives for each field. In this manner, question-specific, and thus, standards-specific, scores can be recorded in various relational ways to provide flexible data for monitoring, tracking, assessing and steering student performance toward measurable goals for meeting educational standards-relevant factors.

Moreover, software and methods can be provided for recommending follow up teaching activities, based on the standards-specific score data recorded using the grading chart. In some embodiments of the present invention, performance indicators are calculated or generated, using the standards-specific score data. The performance indicators are then used to recommend type or frequency of future questions to administer, or type or frequency of lessons, or the focus of lessons.

Computer software products, computer implemented methods and methods of teaching are also provided for carrying out various embodiments of the present invention.

### BRIEF DESCRIPTION OF THE DRAWINGS

FIG. 1a shows an embodiment of a grading chart of the present invention.

FIG. 1b illustrates an example of a paper-based response to a set of inquiries, for illustrative purposes.

FIG. 2 illustrates an example embodiment of a computer system for use with some embodiments of the present invention.

FIG. 3 illustrates a set of frames for a field of the grading chart, as a user toggles through a pre-designated set of score alternatives displayable in the field.

FIG. 4 shows a portion of a grading chart of the present invention wherein the fields in the grading chart comprise scaled scores.

FIG. 5 shows a scoring table for an embodiment of the present invention, which can be associated with a field of the grading chart, the scoring table being usable for entry of quantitative scores.

FIG. 6 shows a portion of a grading chart of the present invention, wherein the fields comprise split fields having at least two scoring sections, usable for scoring the same question in different scoring formats.

FIG. 7 shows an example bar graph representing performance for students in various categories.

FIG. 8 shows an example matrix with performance indicators shown for a plurality of individual students.

### DETAILED DESCRIPTION OF PREFERRED EMBODIMENTS

In the following description, certain specific details are set forth in order to provide a thorough understanding of various embodiments of the invention. However, upon reviewing this disclosure, one skilled in the art will understand that the invention may be practiced without many of these details. In other instances, well-known structures associated with computer systems have not been described in detail to avoid unnecessarily obscuring the descriptions of the embodiments of the invention.

Throughout various portions of the following description, the embodiments of the present invention are described in the context of teachers grading student questions. However, as will be understood by one skilled in the art after reviewing this disclosure, various embodiments of the present invention have a wide variety of applications for other testing, assessments or survey responses, and the context of the description is not intended to be restrictive unless otherwise indicated.

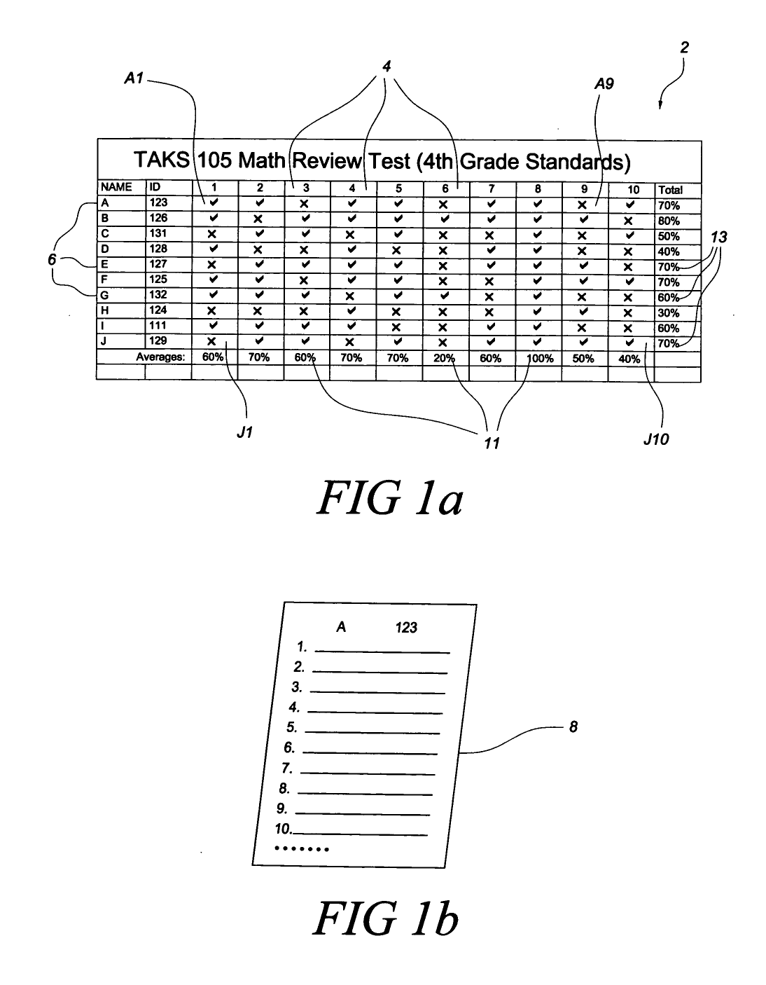

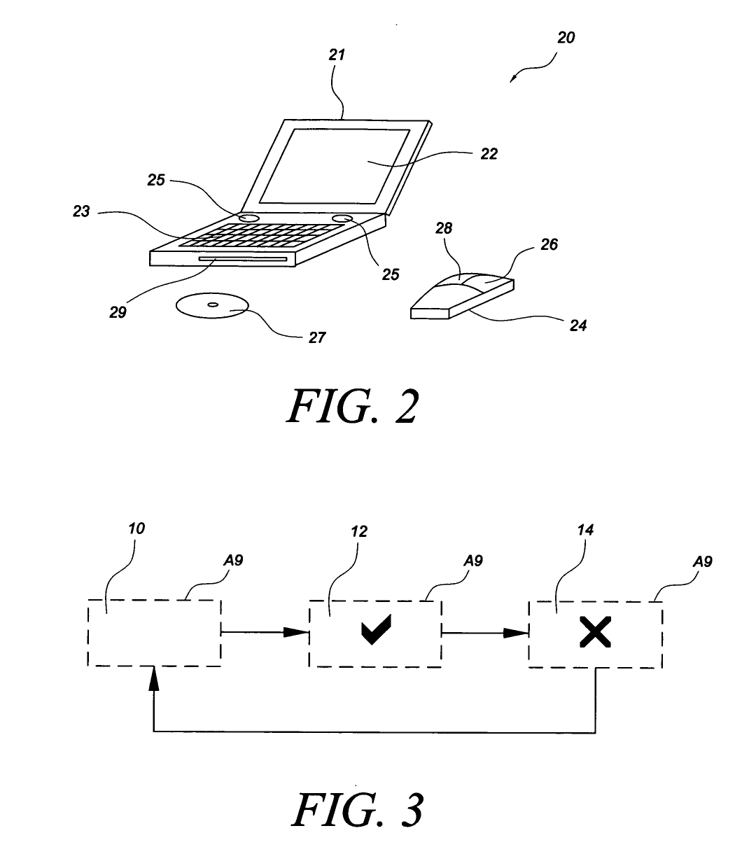

In some embodiments of the present invention, a grading chart 2, or matrix, is provided, such as that shown in FIG. 1a. The grading chart 2 can be displayed on a computer monitor 22 of a computer system 20, as shown in FIG. 2. The grading chart 2 can have scoring columns 4, and can be assigned rows 6 associated with students. Thus, each cell, such as those illustrated as fields A1-J10 in FIG. 1a, can be used to graphically record and display scores for question answers provided by students, wherein the letters A through J (“A-J”) represent students, and the numbers 1 through 10 (“1-10”) correspond to fields for recording answers to questions #1 through #10, etc., of a test or quiz. As will be appreciated by those skilled in the art after reviewing this disclosure, any number of student rows 6 or scoring columns 4 can be provided in the grading chart 2, depending on the number of students and number of questions for any particular test or quiz.

In some embodiments of the present invention, a user, such as a teacher, can grade a student's paper-based responses using the grading chart 2 on a display 22 of a computer system 20. The teacher can use a field-selection member, which can be a pointer or mouse 24, to point at and select a field from fields A1-J10, and then enter a score in the field using one or more input members (keypad 23 or mouse 24) of the computer system 20.

Entering scores in fields can comprise manual entry of scores using a keypad 23, or can comprise toggling between pre-programmed or pre-designated score alternatives for each field using a button, such as button 28 on the mouse 24. Toggling between pre-designated score alternatives can facilitate faster data entry. For example, for illustrative purposes, assume that a student “A” provides a response to a question #9 shown on the paper 8 of FIG. 1b. In this example, the student's response to question #9 can be scored as either “correct” or “incorrect.” A teacher grading the paper 8 for student “A” selects field A9 (representing student A, question #9) on the grading chart 2 of FIG. 1a, using a pointer device 24. Now referring to FIG. 3, the teacher can toggle between pre-designated score alternatives for field A9, as shown in frames 10-14, using a button on the pointer devices, such as mouse button 28. When field A9 is initially selected, it can be blank as shown in frame 10, of FIG. 3. Depressing an input member, such as the mouse button 28, can cause the indication in field A9 to toggle and illustrate a “check mark,” or other symbol representing a “correct” score, as shown in frame 12, while depressing the mouse button 28 again can cause field A9 to toggle to an “X” or other symbol representing an “incorrect” score, as shown in frame 14, of FIG. 3. Depressing mouse button 28 once again can cause the blank indication, frame 10, to reappear, and so on and so forth. In this manner, a teacher is able to toggle between pre-designated score alternatives (e.g. “correct” or “incorrect”) to score the student's response. In some embodiments, the selected scores are automatically stored when selected, and replaced when other selections are made by toggling through score alternatives.

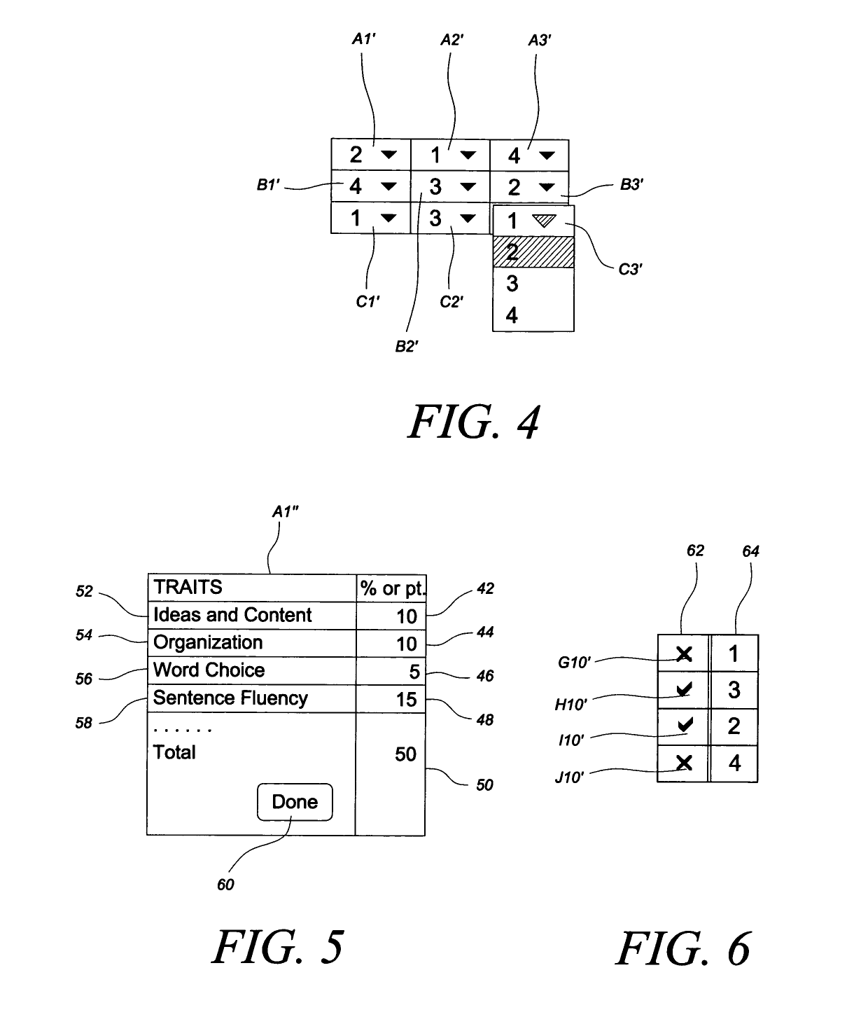

Now referring to FIG. 4, in further embodiments of the present invention, some alternative fields A1′-C3′ of the grading chart 2 can be configured to be linked with a pull down display, or other display configuration for simultaneously displaying pre-designated score alternatives. The pull down display can be activated when a particular field is selected, such as field C3′ in FIG. 4. The pull down display provides selectable score alternatives that can be highlighted and selected using a pointer, such the mouse 24. In the illustrated example embodiment of FIG. 4, a question corresponding to field C3′ can be graded using one of the quantitative scores represented by the numbers 1, 2, 3 or 4. Whichever score a grader selects can then be displayed in the corresponding field.

Referring to FIG. 5, in yet a further embodiment of the present invention, one or more fields of grading chart 2 can be associated with a scoring table. The scoring table in FIG. 5 can have multiple sections and be displayed when a field A1″ of the grading chart 2 is selected (field A1″ is also not illustrated in FIG. 1a as part of the grading chart 2, but it is contemplated that field A1″, and other similarly or identically configured fields, can be part of the grading chart 2 in various embodiments thereof). When a field is selected having an associated scoring table, such as field A1″, the scoring table can be displayed automatically. The scoring table can then be used to visually enter scores by category. That is, in the illustrated example, the scoring table of FIG. 5 has sections 42, 44, 46, 48 for entering scores corresponding to categories 52, 54, 56 and 58 for grading an essay response, the categories representing “ideas and content” 52, “organization” 54, “word choice” 56, and “sentence fluency” 58. A teacher can enter scores, such as numerical scores, in the sections 42, 44, 46, 48 for each corresponding category, using a keypad 23 and can select to store the entries, such as by, for example, pointing and clicking on a graphical button, such as the graphical button 60 labeled “done” in FIG. 5. In some embodiments, after the entries are complete, the numerical total of the scores entered in the scoring table can be displayed as a single number in the field A1″ of the grading chart 2.

As illustrated in FIG. 6, other embodiments of the grading chart 2 can comprise split fields having more than one section for entering scores or notations in different formats. For example, fields G10′-J10′ each have left side sections 62 and right side sections 64, wherein each of the fields correspond to one question which can be scored in two different formats. For illustrative purposes, FIG. 6 shows section 62 for recording a “correct” or “incorrect” score for a question response, and section 64 for recording a quantitative score. Various other combinations and number of sections can be used for each field in different embodiments. The different types of scoring sections for each field can be useful for an educator to record more than one relevant form of data with respect to a question response. This can provide additional information for tracking and evaluating student progress or performance, as will be appreciated by those skilled in the art after reviewing this disclosure.

It is also noted that various embodiments of the grading chart 2 can comprise a combination of a plurality of different field types (such as those illustrated as fields A1-J10, A1′-C3′, A1″ and G10′-J10′), in any of various occurrence patterns, as may be suitable for grading particular tests or quizzes. The particular configuration of any given grading chart 2, just like the pre-designed score alternatives, can be pre-programmed to match, or automatically associated with, a set of questions in a given test or quiz. The teacher, or associated software application or component, can then conveniently select the appropriate grading chart to correspond to a given test or quiz, and quickly configure the grading chart to score student responses.

As disclosed above, fields on the grading chart 2 can be selected for data entry using a pointer device. In further embodiments of the present invention, fields can also be selected by toggling through fields using an input member, such as a second mouse button 26, or other input member. A teacher can therefore toggle through both field selection and score alternatives available for each field, using different input members or buttons. For example, without limitation, where the score alternatives for a particular quiz consist only of “correct” or “incorrect” scores, in accordance with the embodiment shown in FIG. 3, a teacher can toggle between the scores alternatives in each field using a first input member, while successively toggling through fields using a second input member in order to enter a score in each field. As will be appreciated by those skilled in the art after reviewing this disclosure, it is therefore possible, with practice, for a teacher to grade tests, quizzes or other papers 8 using toggling functions, while minimizing visual contact with the computer monitor 22, which can further facilitate quick and efficient grading of tests and quizzes.

In some embodiments of the present invention, the grading chart 2 can have default settings that can be triggered by a user via clicking (using a pointer 24) on or otherwise selecting an area of the grading chart. For example, a user can select a column heading, which may represent a question number, on the grading chart 2 to set all scores in the fields of the column to the same score (e.g., “correct”). The user can also select a row, which may represent an individual student and the student's score, to set all scores for the student to the same score. The same can be true of the entire grading chart 2, wherein a user can point and click on a preprogrammed location on the grading chart to set all of the fields in the grading chart to a default score or setting. These features can be useful in certain grading situations, where it is expected that a particular result will be more common in the fields for which a default setting is used. The person scoring then only has to select scores in fields that deviate from the expected scores during grading.

It is further noted that the grading chart 2 can have rows or columns with fields that depict calculated performance indicators (such as percentage correct). For example, in the embodiment illustrated in FIG. 1a, the bottom row has fields 11 that display the percentage of students that have answered each question correctly. Also, the leftmost column has fields 13 that display the percentage of questions each student has answered correctly.

In some embodiments of the present invention, the grading chart 2, of FIG. 1a, is used independently of any other application. In other embodiments, the grading chart 2 is used with, or as part of, other computer-executable instructions having components for analyzing, monitoring or storing student performance data. The computer-executable instructions can stored on a computer readable medium, such as that shown in FIG. 2, including, without limitation, CD-ROM disks 27, floppy disks, tapes, flash memory, system memory, DVD-ROM, or hard drives for computers 21 and can be tailored to assist educators in complying with NCLB requirements, including meeting AYP or other compliance measures. To facilitate such application, each field of the grading chart 2 can be linked or associated with one or more educational standards-relevant factors (such as, without limitation, learning objectives). For example, questions administered during ongoing assessments can be framed to measure and gauge student proficiency and progress toward various state learning objectives. The questions can thus be pre-associated with learning objectives, or other standards-relevant factors. As will be appreciated by those skilled in the art after reviewing this disclosure, in some embodiments of the present invention, when a particular set of questions (which are pre-associated with learning objectives via a compatible portion of software) are graded, the grading chart 2 is configured to automatically associate or link each selected score within a field (e.g., A1-J10, A1′-C3′, A1″ and G10′-J10′) to the one or more learning objectives as a function of the corresponding question. Scores entered in the fields can thus each be stored relationally with respect to various factors, such as learning objectives or other standards-relevant factors, or individual students or their social, economic, or legal categories. Such relational data is then used for monitoring and analysis to help educators assess, track and steer student progress in relation to relevant state standards.

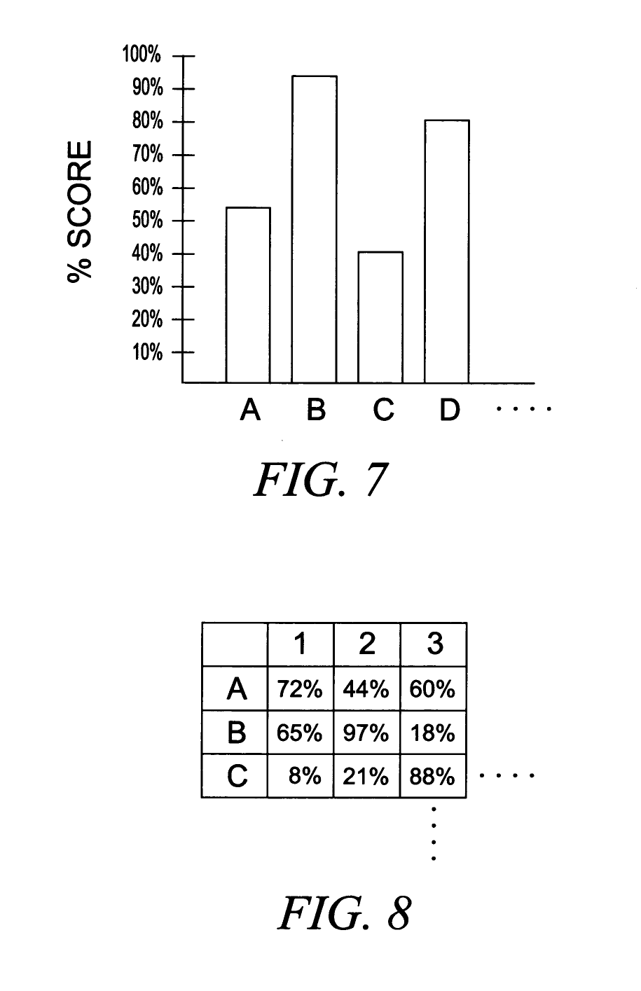

For example, software products or methods can be provided to display student performance data in comparison with standards-relevant factors, to compare student performance against state requirements. Any student's overall performance, performance per assessment, or individual question scores in relation to one or more standards-relevant factors, can be depicted in graphical formats, such as tables, graphs and charts. Also, student performance data can be presented for display in various aggregates (e.g., classroom, school, district or state) in relation to any of a variety of social, economic, performance, or legal categories, with such relationships depicted numerically, graphically or otherwise. Referring to FIG. 7, in some embodiments, student performance for a school is presented as a bar graph, with each bar (A, B, C, D, etc.) representing an overall average score on questions directed toward multiple combined learning objectives for a specific ethnicity. In another example, in FIG. 8, performance data for individual students is presented in a matrix, with performance indicators, such as percentage of questions correct, depicted under different learning objective categories in columns (1, 2, 3, etc.) and with students named individually on each row (A, B, C, etc.) of the matrix, in order for a teacher to see how each student is performing, or has performed, with respect to various learning objectives. The performance indictors can also be, for example, average score for a particular type of question under a learning objective category or a graphical depiction (e.g. bar graph with height proportional to student's score out of best possible score). The matrix data can also be based on an aggregate of data over a specified time, or a snapshot of data for a particular day, test or quiz. Moreover, in some embodiments, a student's performance in relation to a learning objective can be trended, or tracked by comparison with past performance data to evaluate student progress. The trends can be presented in graphs or other widely used formats. In addition, compatible computer software can be provided to analyze trends and student, class or school proficiency reflected by the data in relation to learning objectives, and to recommend follow up actions for teachers, such as focusing teachers on particular lessons, subject areas or skill sets. All of the performance indicators (e.g., graphs, tables, charts, matrices, trends, and measurements generated from aggregates of scores, such as percentages and averages) can be used as variables to drive recommended follow up actions, such as lessons, quizzes, tests or questions, that can be recommended by the computer-executable instructions for various embodiments of the present invention. For example, some computer-executable instructions can analyze performance indicators to determine where students are performing poorly, and to recommend questions for near term future ongoing assessments directed toward that area, such as a learning objective, along with future lessons in preparing for such questions. As one skilled in the art will appreciate after reviewing this disclosure, the possible formats in which to present and use such data are numerous. The present invention provides, among other things, methods for collecting the data in a uniquely compatible manner with computer software applications and components usable for educational standards compliance.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A computer implemented method of recording and analyzing student scores using a grading chart display having a plurality of fields, each of the plurality of fields being usable to select and display a score corresponding to a response to an inquiry provided by a student, the method comprising:
receiving an input signal representing the selection of a field on the grading chart;
receiving a plurality of input signals for toggling between pre-designated score alternatives and displaying the score alternatives in the field as they are toggled;
storing a score from among the pre-designated score alternatives for representing a student response to an inquiry; and
associating the stored score with at least one educational standards-relevant factor for use in analysis of student performance.

2. The method of claim 1 further comprising receiving a numerical input from a keypad for display in a field of the grading chart, the numerical input being independent of any pre-designated score alternative.

3. The method of claim 2 wherein the numerical input can be displayed in a scoring table displayable in the grading chart.

4. The method of claim 1 further comprising displaying a plurality of selectable scores simultaneously when at least one of the plurality of fields is selected.

5. The method of claim 1 wherein at least one of the fields in the grading chart is displayed as a split field having a plurality of sections available for entry of scores, with each section being capable of receiving a score in a different format.

6. The method of claim 1 wherein a user can set data displayed in a plurality of fields in the grading chart to a default score by selecting a portion of the grading chart using an input member.

7. A computer implemented method of tracking and assessing student performance comprising:
(a) displaying on a display device, a grading chart having a plurality of fields, each field being configured to be capable of displaying a score corresponding to a question response provided by a student;
(b) receiving an input signal from a first input member for selecting a field in the grading chart;
(c) receiving a signal from a second input member for selecting between pre-designated score alternatives assigned to the field and displaying the selected score in the selected field; and
(d) repeating steps (b) and (c) a plurality of times to select and display other scores in other fields, wherein each of the fields is associated with at least one educational standards-relevant factor.

8. The method of claim 7 wherein the signal received from the second input member toggles through the pre-designated score alternatives.

9. The method of claim 7 wherein the pre-designated score alternatives are simultaneously displayable in a graphical display when the field is selected.

10. The method of claim 7 wherein when another of the plurality of fields is selected, a scoring table is displayed for entering scores in relation to a plurality of categories of scoring.

11. The method of claim 7 wherein the selected field is a split field having a plurality of sections available for entry of scores, with each section being capable of receiving a score in a different format in relation to a single question.

12. The method of claim 7 further comprising generating a performance indicator using the selected score for assessing student proficiency or progress in relation to at least one standards-relevant learning objective.

13. The method of claim 12 wherein the performance indicator is a quantitative measurement of student performance over a plurality of questions also using a plurality of other scores, all associated with the at least one standards-relevant learning objective.

14. The method of claim 12 wherein the performance indicator is a percentage correct, average score or graphical summary of a set of responses to questions administered in relation to the at least one standards-relevant learning objective.

15. The method of claim 12 wherein the performance indicator is a trend for viewing student progress.

16. The method of claim 15 wherein the performance indicator is a trend for viewing classroom progress and wherein the trend includes data from a plurality of students in addition to said selected score.

17. The method of claim 15 wherein the performance indicator is a trend for viewing student progress in relation to only the at least one learning objective.

18. A computer readable medium having instructions stored thereon for instructing a computer to execute a method comprising:
displaying a grading chart on a computer display, the grading chart having a plurality of fields for displaying scores, the fields also being linked with pre-designated score alternatives for scoring student responses to questions;
allowing a user to select at least one of the fields and to select a score from among the pre-designated score alternatives, the selected score being automatically associated with a standards-based learning objective; and
generating a student performance indicator using the selected score.

19. The computer readable medium of claim 18 wherein allowing a user to select a score from among the pre-designated score alternatives comprises allowing the user to toggle through the score alternatives using a single input member.

20. The computer readable medium of claim 18 wherein allowing a user to select a score from among the pre-designated score alternatives comprises displaying a plurality of score alternatives simultaneously when the at least one of the fields is selected.

21. The computer readable medium of claim 18 further comprising allowing a user to select at least another of the fields and wherein when the another of the fields is selected, a scoring table can be displayed and used for entering a plurality of scores in association with a plurality of categories for scoring an essay question.

22. The computer readable medium of claim 18 wherein the selected field has at least two sections, with each section being configured for displaying a different score type for the same response.

23. A method of teaching comprising:
displaying an assessment score chart on a display device having a plurality of fields, each field being configured to display a score corresponding to a paper based response to a question;
selecting a field in the assessment score chart;
selecting a score from among a plurality of pre-designated scores associated with the selected field;
generating a performance indicator for a student or classroom using the selected score; and
recommending a teaching activity based on the performance indicator.

24. The method of claim 23 wherein selecting a score comprises toggling between the pre-designated scores or selecting a score from a plurality of simultaneously displayable scores.

25. The method of claim 23 wherein the recommended teaching activity is administering a question directed toward a particular set of learning objectives, or a single learning objective.

26. The method of claim 25 wherein the recommended activity further comprises a particular lesson for teaching a particular set of learning objectives or a single learning objective.

27. The method of claim 23 wherein the recommended activity is a lesson designed to teach a particular skill related to a learning objective.
